(19) United States
(12) Patent Application Publication
(10) Pub. No.: US 2021/0343212 A1
(43) Pub. Date: Nov. 4, 2021

(54) DISPLAYING METHOD, DISPLAYING DEVICE, AND INTEGRATED CIRCUIT

(71) Applicant: NOVATEK Microelectronics Corp., Hsinchu (TW)

(72) Inventors: Yung-Cheng TSAI, Hsinchu City (TW); Feng-Ting PAI, Hsinchu City (TW)

(21) Appl. No.: 16/864,173

(22) Filed: May 1, 2020

(51) Int. Cl. G09G 3/20; G09G 5/10

(52) U.S. Cl. CPC G09G 3/20; G09G 5/10; G09G 2310/027; G09G 2340/0407; G09G 2320/0686; G09G 2340/0457

(57) ABSTRACT

A displaying method for displaying an image on a displaying panel including a first area having a first resolution and a second area having a second resolution lower than the first resolution is disclosed. The displaying method includes the following operations: determining a part of the first area as a third area, wherein the third area is adjacent to the second area; applying a mask to the third area, so that a third resolution applicable in the third area is between the first resolution and the second resolution; and displaying the image according to corresponding resolutions in the first, the second and the third areas of the displaying panel, respectively.

### FIELD OF INVENTION

The invention relates to a displaying method, a displaying device, and an integrated circuit. More particularly, the invention relates to a displaying method, a displaying device, and an integrated circuit for displaying panels with different solutions.

### BACKGROUND

Due to different requirements, the displaying panel may include several different resolutions, different arrangement of color units, or arrangement densities on the same displaying panel at the same time. In general, the displayed effect at the junction of two different resolutions will be obvious, affecting the user experience.

### SUMMARY

An embodiment of this disclosure is to provide a displaying method for displaying an image on a displaying panel including a first area having a first resolution and a second area having a second resolution lower than the first resolution. The displaying method includes the following operations: determining a part of the first area as a third area, wherein the third area is adjacent to the second area; applying a mask to the third area, so that a third resolution applicable in the third area is between the first resolution and the second resolution; and displaying the image according to corresponding resolutions in the first, the second and the third areas of the displaying panel, respectively.

Another embodiment of this disclosure is to provide a displaying device. The displaying device includes a displaying panel and a controlling circuit. The displaying panel includes a first area with a first resolution and a second area with a second resolution. The first resolution is higher than the second resolution. The controlling circuit is configured to determine a part of the first area to be the third area, and to apply a mask to the third area, so that a third resolution of the third area is between the first resolution and the second resolution, wherein the third area is adjacent to the second area, wherein the controlling circuit is further configured to display a image on the displaying panel according to corresponding resolutions of the first, the second, and the third areas of the displaying panel, respectively.

Another embodiment of this disclosure is to provide an integrated circuit. The integrated circuit is coupled to a displaying panel comprising a first area with a first resolution and a second area with a second resolution. The first resolution is higher than the second resolution. The integrated circuit is configured to determine a part of the first area to be the third area, and to apply a mask to the third area, so that a third resolution of the third area is between the first resolution and the second resolution, wherein the third area is adjacent to the second area. The integrated circuit is further configured to display a image according to corresponding resolutions in the first, the second and the third areas of the displaying panel, respectively.

Therefore, according to the technical concept of the present invention, embodiments of this disclosure are to provide a displaying method, a displaying device, and an integrated circuit. By applying a mask to the area with higher resolution, an area with a virtual resolution is achieved, and the difference between the displaying effect between the different resolutions of the displaying panel is smoothened, in which the user experience is improved.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a displaying device according to some embodiments of the present disclosure.

FIG. 2 is a schematic diagram illustrating a displaying panel according to some embodiments of the present disclosure.

FIG. 3 is a flowchart of a displaying method suitable to be applied on the displaying device in FIG. 1, in accordance with one embodiment of the present disclosure.

FIG. 4 is a schematic diagram illustrating a mask according to some embodiments of the present disclosure.

FIG. 5 is a schematic diagram illustrating another displaying panel according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

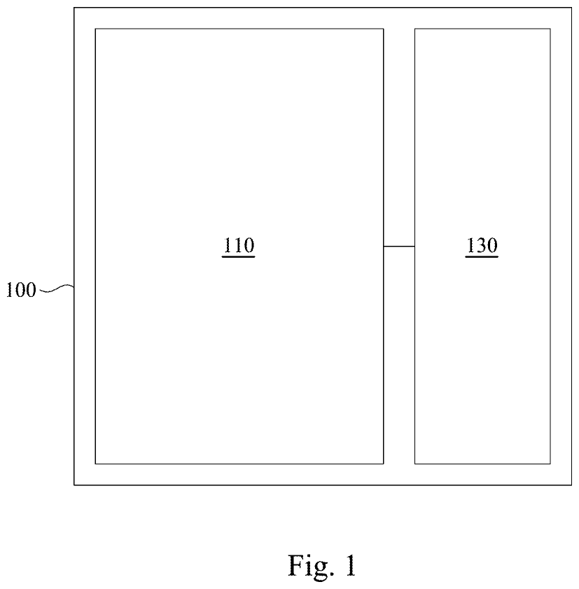

Reference is made to FIG. 1. FIG. 1 is a schematic diagram illustrating a displaying device 100 according to some embodiments of the present disclosure. As illustrated in FIG. 1, the displaying device 100 includes a displaying panel 110 and a controlling circuit 130. The displaying panel 110 is coupled to the controlling circuit 130. It should be noted that, the displaying device as illustrated in FIG. 1 is for illustrative only, and the embodiments of the present disclosure are not limited thereto.

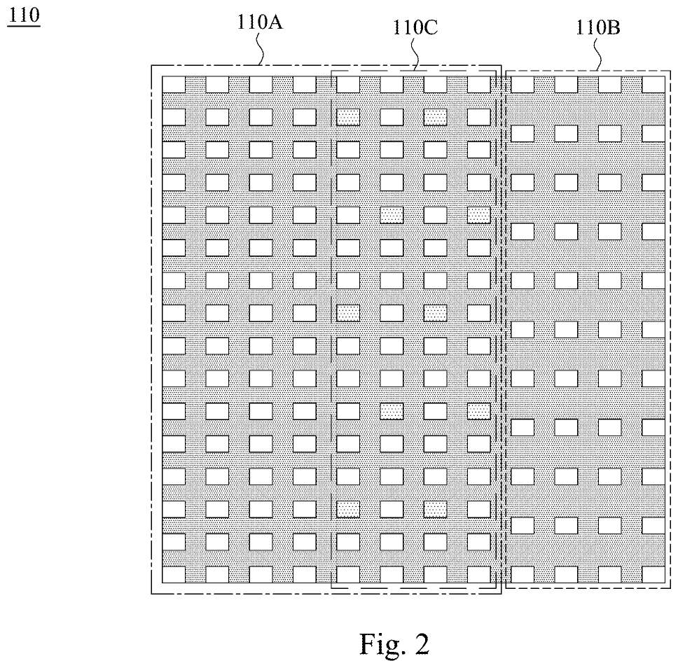

Reference is made to FIG. 2. FIG. 2 is a schematic diagram illustrating a displaying panel 110 according to some embodiments of the present disclosure. As illustrated in FIG. 2, the displaying panel 110 includes a first area 110A and a second area 110B. The first area includes a first resolution and the second area includes a second resolution. The second resolution is lower than the first resolution. In some embodiments, a pixel intensity of the first area 110A is higher than a pixel intensity of the second area 110B.

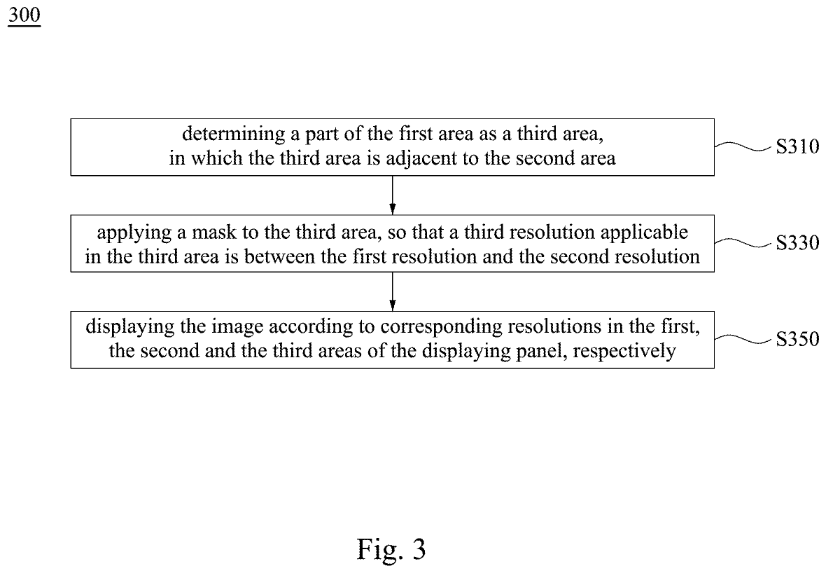

Details of the present disclosure are described in the paragraphs below with reference to a displaying method in FIG. 3, in which FIG. 3 is a flowchart of a displaying method 300 suitable to be applied on the displaying device 100 in FIG. 1, in accordance with one embodiment of the present disclosure. However, the present disclosure is not limited to the embodiment below.

It should be noted that the displaying method 300 can be applied to a electronic device having a structure that is the same as or similar to the structure of the displaying device 100 shown in FIG. 1. To simplify the description below, the embodiment shown in FIG. 1 will be used as an example to describe the displaying method according to an embodiment of the present disclosure. However, the present disclosure is not limited to application to the embodiment shown in FIG. 1.

In addition, it should be noted that in the operations of the following displaying method, no particular sequence is required unless otherwise specified. Moreover, the following operations also may be performed simultaneously or the execution times thereof may at least partially overlap.

Furthermore, the operations of the following displaying method may be added to, replaced, and/or eliminated as appropriate, in accordance with various embodiments of the present disclosure.

Reference is made to FIGS. 1, 2 and 3. The displaying method 300 includes the operations below.

In operation S310, determining a part of the first area as a third area, in which the third area is adjacent to the second area. In some embodiments, operation S310 may be operated by the controlling circuit 130 as illustrated in FIG. 1. For example, the controlling circuit 130 determines a part of the first area 110A as a third area 110C. The third area 110C is adjacent to the second area 110B. The range of the third area 110C may be determined by the controlling circuit 130 in accordance with different situation, and the embodiments of the present disclosure are not limited thereto.

In operation S330, applying a mask to the third area, so that a third resolution applicable in the third area is between the first resolution and the second resolution. In some embodiments, the operation S330 may be operated by the controlling circuit 130. That is, the controlling circuit 130 as illustrated in FIG. 1 may apply a mask to the third area 110C in FIG. 2, so that a third resolution of the third area 110C is between the first resolution of the area 110A and the second resolution of the area 110B.

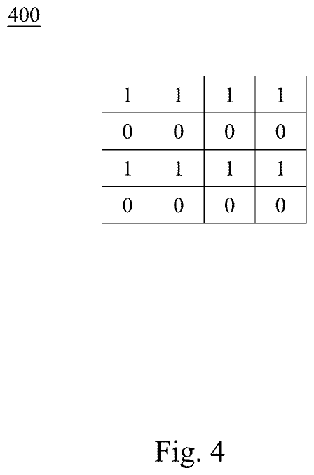

In some embodiments, the mask includes several weighting values with a regular pattern. Reference is made to FIG. 4. FIG. 4 is a schematic diagram illustrating a mask 400 according to some embodiments of the present disclosure. It should be noted that, the weighting, the regularity, or the range of the mask 400 shown in FIG. 4 is for illustrative purposes only, and the embodiments of the present disclosure are not limited thereto.

In some embodiments, when the first area 110A is a standard area, the controlling circuit 130 adjusts a brightness of the second area 110B and a brightness of the third area 110C, so that the brightness of the second area 110B and the brightness of the third area 110C are the same as the brightness of the first area 110A. Similarly, when the second area 110B is a standard area, the controlling circuit 130 adjusts the brightness of the first area 110A and the brightness of the third area 110C, so that the brightness of the first area 110A and the brightness of the third area 110C are the same as the brightness of the second area 110B.

In some embodiments, the brightness of the area with the lower resolution may not be able to be adjusted to be the same as the brightness of the area with higher resolution. Therefore, after adjustment, the brightness of the area with higher resolution is greater than or equal to the brightness of the area with lower resolution. Take FIG. 2 as an example, in some embodiments, after adjustment, the brightness of the first area 110A is greater than or equal to the brightness of the third area 110C, and the brightness of the third area 110C is greater than or equal to the brightness of the second area 110B.

In some embodiments, adjusting the brightness of the third area 110C may be realized by adjusting a RGB gray scale of a data input to the third area 110C before a SPR (sub pixel rendering) adjustment so that the brightness of the third area 110C is between a brightness of the first area 110A and a brightness of the second area 110B, in which the brightness of the first area 110A is greater than the brightness of the second area 110B.

In some embodiments, adjusting the brightness of the third area 110C is realized by adjusting a RGB gray scale of a data input to the third area 110C after a SPR (sub pixel rendering) adjustment so that the brightness of the third area 110C is between a brightness of the first area 110A and a brightness of the second area 110B, in which the brightness of the first area 110A is greater than the brightness of the second area 110B.

In some embodiments, adjusting a brightness of the third area 110C is realized by adjusting a RGB gamma value input to the third area 110C so that the brightness of the third area 110C is between a brightness of the first area 110A and a brightness of the second area 110B, in which the brightness of the first area 110A is greater than the brightness of the second area 110B.

In some embodiments, adjusting the brightness of the third area 110C is realized by adjusting an output voltage value or a flickering frequency input to the third area 110C so that the brightness of the third area 110C is between a brightness of the first area 110A and a brightness of the second area 110B, in which the brightness of the first area 110A is greater than the brightness of the second area 110B.

In some embodiments, the mask 400 is applied to the third area 110C before the SPR adjustment or after the SPR adjustment.

In some embodiments, the controlling circuit 130 further adjusts a weighting of the mask 400 in combination with an adjustment of a brightness of the third area 110C.

In operation S350, displaying the image according to corresponding resolutions in the first, the second and the third areas of the displaying panel, respectively. In some embodiments, the operation S350 may be operated by the controlling circuit 130. That is, the controlling circuit 130 may display the image according to the first resolution in the first area 110A, the second resolution in the second area 110B, and the third resolution in the third area 110C, as illustrated in FIG. 2.

It should be noted that, the example mentioning above takes a displaying device with two areas of different resolutions as an example, as shown in FIG. 2. However, the embodiments of the present disclosure are not limited thereto. Any displaying devices with two or more areas of different resolutions are within the scope of the present disclosure. Moreover, the displaying method of the present disclosure may be applied to any area between two areas with different resolutions.

Furthermore, the number of the third area 110C is not limited to one. Any number of the third area 110C is within the embodiments of the present disclosure. That is, several areas with different resolutions may be created between the first area 110A and the second area 110B.

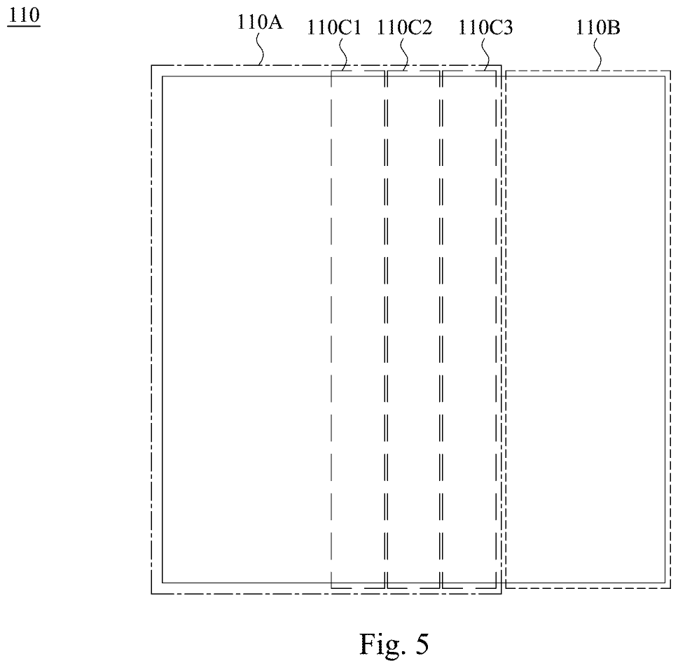

For example, reference is made to FIG. 5. FIG. 5 is a schematic diagram illustrating another displaying panel according to some embodiments of the present disclosure. Assume that the resolution of the first area 110A is 600 ppi (Pixels Per Inch) and the resolution of the second area 110B is 200 ppi. Different third areas 110C1 to 110C3 may be created between the first area 110A and the second area 110B. In detail, the resolution of the third area 110C1 is 500 ppi, the resolution of the third area 110C2 is 400 ppi, and the resolution of the third area 110C3 is 300 ppi. The more the number of the third areas 110C, the displaying effect between the different resolutions of the displaying panel is smoothened better.

In some embodiments, the controlling circuit 130 is configured to run or execute various software programs and/or sets of instructions to perform various functions to process data. In one embodiment, the controlling circuit 130 may be realized by an integrated circuit. In some embodiments, the controlling circuit 130 can be realized by, for example, one or more processors, such as central processors and/or microprocessors, but are not limited in this regard.

In some embodiments, the displaying panel 110 can be realized by, for example, a display, such as a liquid crystal display or an active matrix organic light emitting diode (AMOLED) display, but is not limited in this regard.

It may be known from the embodiments mentioning above, the embodiments of the present disclosure provide a displaying method, a displaying device, and an integrated circuit. By applying a mask to the area with higher resolution, an area with a virtual resolution is achieved, and the difference between the displaying effect between the different resolutions of the displaying panel is smoothened, in which the user experience is improved.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one unit from another. For example, a first unit could be termed a second element, and, similarly, a second unit could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A displaying method for displaying an image on a displaying panel which comprises a first area having a first resolution and a second area having a second resolution lower than the first resolution, comprising:
determining a part of the first area as a third area, wherein the third area is adjacent to the second area;
applying a mask to the third area, so that a third resolution applicable in the third area is between the first resolution and the second resolution; and
displaying the image according to corresponding resolutions in the first, the second and the third areas of the displaying panel, respectively.

2. The displaying method of claim 1, wherein a pixel intensity of the first area is higher than a pixel intensity of the second area.

3. The displaying method of claim 1, further comprising:
adjusting a brightness of the second area and a brightness of the third area when the first area is a standard area; and
adjusting the brightness of the first area and the brightness of the third area when the second area is a standard area.

4. The displaying method of claim 1, further comprising:
adjusting a brightness of the third area by adjusting a RGB gray scale of a data input to the third area before a SPR (sub pixel rendering) adjustment so that the brightness of the third area is between a brightness of the first area and a brightness of the second area.

5. The displaying method of claim 1, further comprising:
adjusting a brightness of the third area by adjusting a RGB gray scale of a data input to the third area after a SPR (sub pixel rendering) adjustment so that the brightness of the third area is between a brightness of the first area and a brightness of the second area.

6. The displaying method of claim 1, further comprising:
adjusting a brightness of the third area by adjusting a RGB gamma value input to the third area so that the brightness of the third area is between a brightness of the first area and a brightness of the second area.

7. The displaying method of claim 1, further comprising:
adjusting a brightness of the third area by adjusting an output voltage value or a flickering frequency input to the third area so that the brightness of the third area is between a brightness of the first area and a brightness of the second area.

8. The displaying method of claim 1, further comprising:
applying the mask to the third area before a SPR (sub pixel rendering) adjustment.

9. The displaying method of claim 1, further comprising:
applying the mask to the third area after a SPR (sub pixel rendering) adjustment.

10. The displaying method of claim 1, further comprising:
adjusting a weighting of the mask in combination with an adjustment of a brightness of the third area.

11. A displaying device, comprising:
a displaying panel, comprising a first area with a first resolution and a second area with a second resolution, wherein the first resolution is higher than the second resolution; and
a controlling circuit, configured to determine a part of the first area to be the third area, and to apply a mask to the third area, so that a third resolution of the third area is between the first resolution and the second resolution, wherein the third area is adjacent to the second area, wherein the controlling circuit is further configured to display a image on the displaying panel according to corresponding resolutions of the first, the second, and the third areas of the displaying panel, respectively.

12. The displaying device of claim 11, wherein the controlling circuit is further configured to adjust a brightness of the second area and a brightness of the third area when the first area is a standard area, and to adjust the brightness of the first area and the brightness of the third area when the second area is a standard area.

13. The displaying device of claim 11, wherein the controlling circuit is further configured to adjust a brightness of the third area by adjusting a RGB gray scale of a data input to the third area before a SPR (sub pixel rendering) adjustment or after the SPR adjustment so that the brightness of the third area is between a brightness of the first area and a brightness of the second area.

14. The displaying device of claim 11, wherein the controlling circuit is further configured to adjust a brightness of the third area by adjusting an output voltage value, a flickering frequency or a RGB gamma value input to the third area so that the brightness of the third area is between a brightness of the first area and a brightness of the second area.

15. The displaying device of claim 11, wherein the controlling circuit is further configured to adjust a weighting of the mask in combination with an adjustment of a brightness of the third area.

16. The displaying device of claim 11, wherein the mask comprises a plurality weighting values with a regular pattern.

17. An integrated circuit, coupled to a displaying panel comprising a first area with a first resolution and a second area with a second resolution, wherein the first resolution is higher than the second resolution, wherein the integrated circuit is configured to determine a part of the first area to be the third area, and to apply a mask to the third area, so that a third resolution of the third area is between the first resolution and the second resolution, wherein the third area is adjacent to the second area, wherein the integrated circuit is further configured to display a image according to corresponding resolutions in the first, the second and the third areas of the displaying panel, respectively.

18. The integrated circuit of claim 17, wherein the integrated circuit is further configured to adjust a brightness of the second area and a brightness of the third area when the first area is a standard area, and to adjust the brightness of the first area and the brightness of the third area when the second area is a standard area.

19. The integrated circuit of claim 17, wherein the integrated circuit is further configured to adjust a brightness of the third area by adjusting an output voltage value, a flickering frequency, or a RGB gamma value input to the third area, or by adjusting a RGB gray scale of a data input to the third area before a SPR (sub pixel rendering) adjustment or after the SPR adjustment, so that the brightness of the third area is between a brightness of the first area and a brightness of the second area.

20. The integrated circuit of claim 17, wherein the integrated circuit is further configured to adjust a weighting of the mask in combination with an adjustment of a brightness of the third area, wherein the mask comprises a plurality weighting values with a regular pattern.
